(19) United States
(12) Patent Application Publication
(10) Pub. No.: US 2015/0364738 A1
(43) Pub. Date: Dec. 17, 2015

(54) BATTERIES INCORPORATING GRAPHENE MEMBRANES FOR EXTENDING THE CYCLE-LIFE OF LITHIUM-ION BATTERIES

(71) Applicants: Michael A. POPE, Princeton, NJ (US); Valerie Alain RIZZO, Princeton, NJ (US); John LETTOW, Princeton, NJ (US); llhan A. AKSAY, Princeton, NJ (US); Daniel DABS, Princeton, NJ (US)

(72) Inventors: Michael A. POPE, Princeton, NJ (US); Valerie Alain RIZZO, Princeton, NJ (US); John LETTOW, Princeton, NJ (US); llhan A. AKSAY, Princeton, NJ (US); Daniel DABS, Princeton, NJ (US)

(73) Assignees: The Trustees of Princeton University, Princeton, NJ (US); Vorbeck Materials Corporation, Jessup, MD (US)

(21) Appl. No.: 14/739,184

(22) Filed: Jun. 15, 2015

Related U.S. Application Data
(60) Provisional application No. 62/012,090, filed on Jun. 13, 2014.

(51) Int. Cl. H01M 2/16; H01M 10/058; H01M 2/14; H01M 4/04; H01M 4/134; H01M 4/38

(52) U.S. Cl. CPC H01M 2/1646; H01M 4/134; H01M 4/382; H01M 2/1673; H01M 4/381; H01M 2/145; H01M 4/04; H01M 10/058; H01M 2004/027

(57) ABSTRACT

Embodiments of the present invention relate to energy storage devices and associated methods of manufacture. In one embodiment, an energy storage device comprises an electrolyte. An anode is at least partially exposed to the electrolyte. A selectively permeable membrane comprising a graphene-based material is positioned proximate to the anode. The selectively permeable membrane reduces a quantity of a component that is included in the electrolyte from contacting the anode and thereby reduces degradation of the anode.

### CROSS-REFERENCE TO RELATED APPLICATIONS

This application claims priority to U.S. Provisional Application No. 62/012,090 filed Jun. 13, 2014, which is hereby incorporated herein by reference.

### STATEMENT REGARDING FEDERALLY SPONSORED RESEARCH OR DEVELOPMENT

This invention was made with government support under Grant No. DE-AR000319 awarded by the Department of Energy, Advanced Research Projects Agency-Energy (ARPA-E). The U.S. Government has certain rights in this invention.

### TECHNICAL FIELD

### Background

The present invention relates generally to batteries and specifically to extending the cycle-life of batteries. Battery anodes composed of materials such as lithium or sodium degrade when the battery is charged or discharged due to the non-uniform deposition and release of material. This degradation can create a porous, reactive material that can cause battery failure by a variety of mechanisms, such as through reactive consumption of the electrolyte, short circuiting of the cell due to dendrite growth across the membrane separator or simply increasing the impedance or resistance of the battery.

### BRIEF DESCRIPTION OF THE DRAWINGS

FIG. 1 depicts a scanning electron micrograph and corresponding elemental mapping, in accordance with an embodiment of the present invention.

FIG. 2 depicts scanning electron micrographs of cross-sections of lithium metal anodes, in accordance with an embodiment of the present invention.

FIG. 3 depicts a voltage v. capacity graph, generally graph A, in accordance with an embodiment of the present invention.

FIG. 4 depicts a voltage v. capacity graph, generally graph B, in accordance with an embodiment of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments are disclosed herein.

Battery anodes (“anodes”) composed of materials such as lithium or sodium can degrade when the battery is charge or discharged due to the non-uniform deposition and release of material. This degradation can create a porous, reactive material that can cause battery failure by a variety of mechanisms, such as through reactive consumption of the electrolyte, short circuiting of the cell due to dendrite growth across the membrane separator or simply increasing the impedance or resistance of the battery.

Disclosed herein are graphene-based membranes, their method of manufacture, and energy storage devices containing these membranes. Applicable energy devices can include, but are not limited to, batteries. Energy storage devices of the present invention can comprise a selectively permeable membrane (“the membrane”) composed of a graphene-based material can be used to reduce the quantity of one or more components included in battery electrolytes from contacting the associated anodes. Anodes can comprise a metal, such as lithium or sodium.

The graphene-based membrane can be prepared from a variety of graphene sources, including but not limited to, graphite, graphite oxide or oxidized graphite, and vaporized carbon precursors. The graphene source can be prepared as disclosed in U.S. Pat. No. 7,658,901 to Prud'Homme et al. The graphene source can be dispersed in solvents prior to membrane production to create a dispersion. Examples of applicable solvents can include, but are not limited to, water, ammoniated water, organic solvents, alcohols (such as ethanol), water/alcohol mixtures (such as ethanol/water), esters and carbonates (such as ethylene carbonate, propylene carbonate), dimethylformamide (DMF), N-methylpyrrolidone (NMP), acetonitrile, and dimethylsulfoxide (DMSO). Ionic, non-ionic or polymer surfactants can be added to the dispersions to facilitate processing.

These dispersions can be used in formation of the membrane without further processing or may undergo further processing, such as being, concentrated, purified, and/or treated with additional additives. To facilitate membrane preparation, the graphene source may be dispersed in solvent using any suitable mixing method, including, but not limited to, ultrasonication, stirring, milling, grinding, and attrition. High-shear mixers, ball mills, attrition equipment, sandmills, two-roll mills, three-roll mills, cryogenic grinding crushers, double planetary mixers, triple planetary mixers, high pressure homogenizers, horizontal and vertical wet grinding mills can be used to form dispersions and blends. Examples of media that can be used for mixing the dispersion including, but are not limited to, metals, carbon steel, stainless steel, ceramics, stabilized ceramic media (such as cerium yttrium stabilized zirconium oxide), PTFE, glass, and tungsten carbide. Dispersions can be formed by generating graphite oxide or graphene from precursor materials (such as graphite or graphite oxide) in a solvent. Dispersions can be used in formation of the membrane without further processing or may undergo further processing, such as being concentrated, purified, and/or treated with additives.

Additives may be added to the dispersions or the membranes to modify their properties. For example, the mechanical properties of the membranes may be improved by covalently linking adjacent sheets within the graphene membrane. The membrane can be cross-linked with, for example, a variety of bi-functional compounds including, but not limited to, diamino compounds, diol compounds, dihalogeno compounds, diacid compounds, or other compounds bearing two functional groups as amine, carboxylic acid, alcohol, aziridine, azomethine ylide, halide derivative of enolate, diene, dienophile, aryl diazonium salt, alkyl halide, acid anhydride and in general nucleophilic and electrophilic organic compounds.

Applicable organic reactions that can be utilized include, but are not limited to, nucleophilic substitution, nucleophilic addition, esterification, amidification, cycloaddition, electrophilic substitution, and free radical reaction. Applicable of solvents can include, but are not limited to, water, ammoniated water, organic solvents, alcohols (such as ethanol), water/alcohol mixtures (such as ethanol/water), esters and carbonates (such as ethylene carbonate, propylene carbonate), dimethylformamide (DMF), N-methylpyrrolidone (NMP), acetonitrile, dimethylsulfoxide (DMSO), tetrahalogenomethane, amine (such as benzylamine), and aromatic solvents (as 1,2-dichlorobenzene (DCB)). Applicable bases can include, but are not limited to, sodium hydride (NaH), 1,8-diazabicyclo[5.4.0]undec-7-ene (DBU), butyllithium, and sodium hydroxide. Catalysts, such as Lewis acid, can be used.

The membrane can be prepared from dispersions through a variety of methods. For example, the dispersion can be applied to one or more sides of a substrate, such as the battery separator or the anode material, before or after performing any suitable surface treatments. Applicable application methods can include, but are not limited to, painting, pouring, tape casting, spin casting, solution casting, dip coating, powder coating, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing, microprinting, pad printing, tampon printing, stencil printing, Langmuir-Blodgett transfer, wire rod coating, drawing, flexographic printing, stamping, xerography, microcontact printing, dip pen nanolithography, laser printing, and via pen or similar means.

Dispersions can be applied in multiple layers. The membranes can have a final thickness of about 0.34 nm to about 100 μm thick. The membrane can have a thickness that promotes a reduction in resistance to ion transport through the graphene membrane. The membranes can be pre-formed on substrates, removed therefrom, and subsequently transferred to storage device components. The membranes may be post-treated, for example, electrochemically, chemically, thermally, photo-chemically, subsequent to their application to render the material conducting to the lithium or sodium ions of interest. For example, the membrane can be contacted with lithium or sodium metal with or without an ion conductor.

The membrane can be inserted between the anode and cathode compartments of the battery either by encapsulating one of the compartments with the material or simply inserting the membrane between the compartments. Typically, there is an electrolyte permeable electrical insulator, typically referred to as a battery separator, between the anode and cathode compartment that can prevent electrical contact and cell shorting. In one embodiment, the membrane can be applied to one or more sides of the battery separator such that one side of the membrane is in electrical contact with the anode.

Another ion conducting material capable of transporting cations of the anode material may be placed between the graphene-based membrane and the anode material to facilitate ion transport between the two materials. However, if there is intimate contact between the membrane and the anode, such an ionic conductor may not be necessary. A suitable cathode material may be placed in the cathode compartment in ionic but not electronic contact with the graphene-based membrane and anode. The anode and cathode can be arranged in a variety of geometries. The anode and cathode can be positioned in close proximity, wherein the battery separator is positioned therebetween. The anode and cathode can be physically separated without a battery separator, but ionically connected through electrolyte filled space.

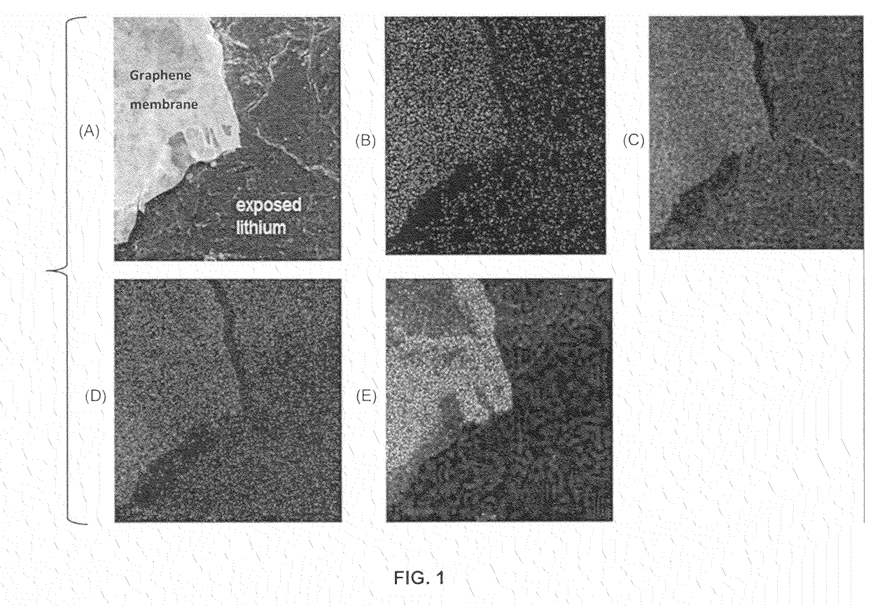

FIGS. 1-4 illustrate that inserting a graphene membrane between the electrolyte and the anode can eliminate or reduce anode deterioration, which can increase the number of cycle times storage devices can undergo prior to failure. In addition, the FIGS. illustrate that the presence of the membrane has little impact on the rate performance of assembled batteries. FIG. 1 depicts a scanning electron micrograph and corresponding elemental mappings, in accordance with an embodiment of the present invention. Specifically, image 1A is an electron micrograph that illustrates a portion of a lithium ion sample, wherein the sample that was exposed to battery electrolytes. The lithium ion sample is partially covered by the graphene membrane.

Images 1B, 1C, 1D, and 1E depict a carbon, oxygen, fluorine, and sulfur elemental mappings of the sample, respectively. The presence of fluorine and sulfur in images 1D and 1E, respectively, indicate that the electrolyte components only contact the graphene membrane and fail to absorb through to the lithium metal. Combined, images 1D and 1E reflect that the membrane acts as a semi-permeable membrane that allows lithium ions to pass back and forth while retaining other components in the cathode chamber.

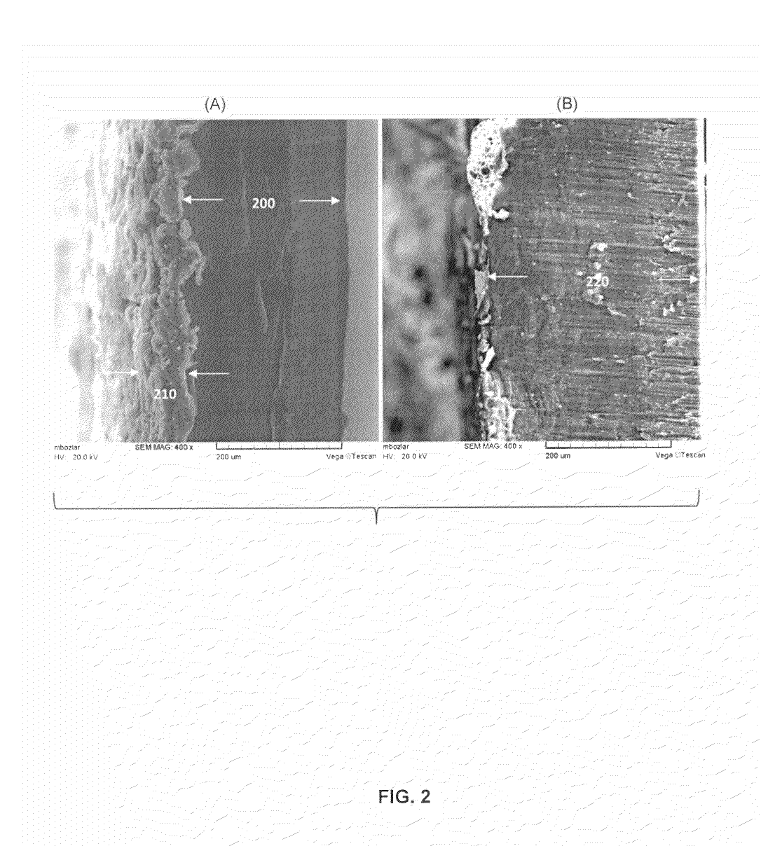

FIG. 2 depicts a scanning electron micrograph of cross-sections of lithium metal anodes, in accordance with an embodiment of the present invention. Specifically, FIG. 2 depicts scanning electron micrographs that show cross-sections of lithium metal anodes after 100 cycles. Image 2A depicts a cross-section of a lithium metal anode, element 200, that lacks the membrane after 100 cycles. Image 2B depicts a cross-section of a lithium metal anode, element 220, having a coating comprised of the membrane at about 700 nm after 100 cycles. Image 2A illustrates that degradation of the unprotected lithium, element 200, is indicated by the thick porous layer, element 210, which is absent in Image 2B.

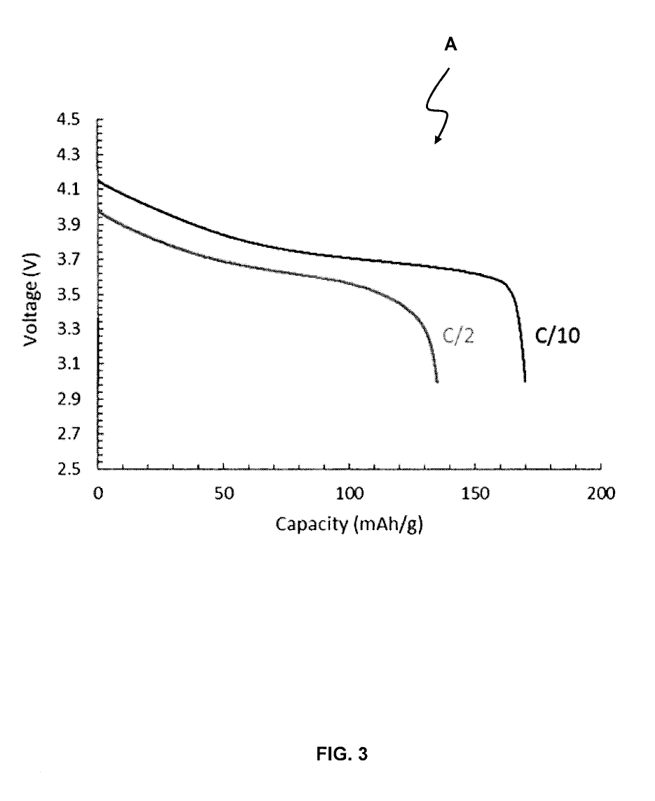

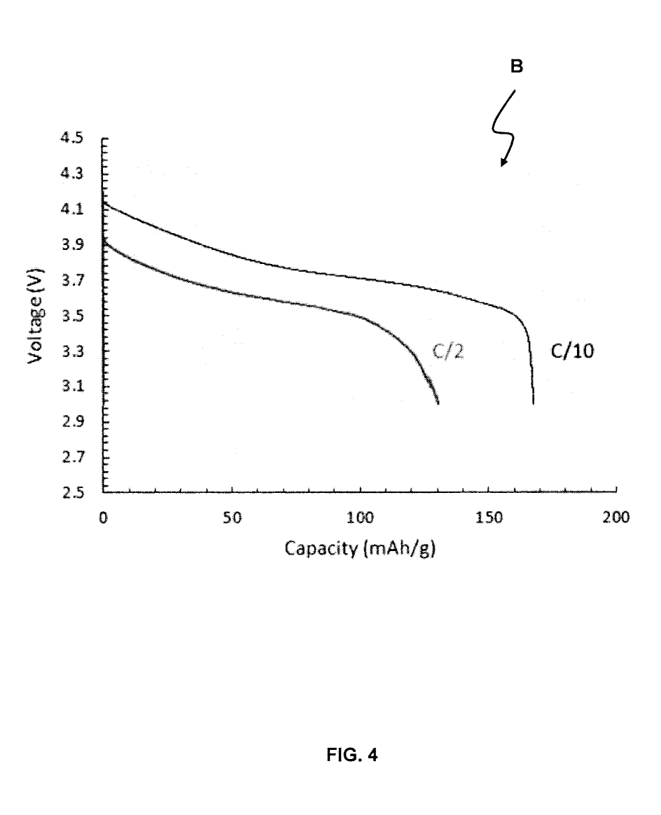

FIG. 3 depicts a voltage v. capacity graph, generally graph A, in accordance with an embodiment of the present invention. Graph A illustrates the capacity at slow (C/10) and fast (C/2) charge/discharge rates for a lithium ion battery assembled without the membrane to protect the lithium metal from degradation. FIG. 4 depicts a voltage v. capacity graph, generally graph B, in accordance with an embodiment of the present invention. Graph B illustrates the capacity at slow (C/10) and fast (C/2) charge/discharge rate for a lithium ion battery assembled with the membrane to protect the lithium metal from degradation. Graphs A and B illustrate that the inclusion of the membrane has a reduced no effect on the rate of performance.

Battery systems of the present invention can be utilized in rechargeable energy storage applications. Such batteries can be utilized for portable or stationary energy storage. Examples of portable energy storage device include, but are not limited to, batteries for hybrid or all-electric cars, buses, trucks or sports utility vehicles, cameras, laptop computers, tablets, toys, and music players. Examples of stationary storage include, but are not limited to, grid level storage, back-up power for industrial or personal use, energy storage buffers or load leveling for renewable energy harvesting.

As various modifications could be made in the constructions and methods herein described and illustrated without departing from the scope of the invention, it is intended that all matter contained in the foregoing description or shown in the accompanying drawings shall be interpreted as illustrative rather than limiting. Thus the breadth and scope of the present invention should not be limited by any of the above-described exemplary embodiments, but should be defined only in accordance with the following claims appended hereto and their equivalents.

What is claimed is:

1. An energy storage device, comprising:
an electrolyte;
an anode at least partially exposed to the electrolyte;
a selectively permeable membrane having a graphene-based material and positioned proximate to the anode;
wherein the selectively permeable membrane is in electrical communication with the anode; and
wherein the selectively permeable membrane reduces a quantity of a component included in the electrolyte from contacting the anode and thereby reduces degradation of the anode.

2. The device of claim 1, further comprising an ion conducting material positioned between the anode and the selectively permeable membrane, and wherein the ion conductive material facilitates transportation of an ion between the anode and the selectively permeable membrane.

3. The device of claim 1 wherein the selectively permeable membrane has a thickness of 0.34 nm to 100 μm.

4. The device of claim 1, further comprising, an electrical insulator positioned proximate to the anode, wherein the electrical insulator is permeable to the electrolyte, wherein the selectively permeable membrane is applied to one or more sides of the permeable electrical insulator, and wherein a side included in the one or more sides is proximate to the anode.

5. The device of claim 1, wherein the anode comprises lithium.

6. The device of claim 1, wherein the selectively permeable membrane increases a quantity of cycles the energy storage device can obtain prior to failure compared to the energy storage device without the selectively permeable membrane.

7. The device of claim 1, wherein the selectively permeable membrane is applied to a surface of the anode.

8. The device of claim 1 wherein the graphene-based material is cross-linked.

9. The device of claim 1, wherein the selectively permeable membrane is initially formed on a substrate prior and then removed from the substrate prior to being positioned proximate to the anode.

10. The device of claim 1, wherein the anode comprises lithium or sodium.

11. A method for assembling an energy storage device, comprising:
providing an anode;
positioning a selectively permeable membrane proximate to the anode;
exposing the anode at least partially to an electrolyte;
wherein the selectively permeable membrane is in electrical communication with the anode;
wherein the selectively permeable membrane comprises a graphene-based material; and
wherein the selectively permeable membrane reduces a quantity of a component included in the electrolyte from contacting the anode in a manner to reduce degradation of the anode.

12. The method of claim 11, further comprising positioning an ion conducting material between the anode and the selectively permeable membrane, and wherein the ion conductive material facilitates transportation of an ion between the anode and the selectively permeable membrane.

13. The method of claim 11, wherein the selectively permeable membrane has a thickness of 0.34 nm to 100 μm.

14. The method of claim 11, further comprising, positioning an electrical insulator proximate to the anode, wherein the electrical insulator is permeable to the electrolyte, wherein the selectively permeable membrane is applied to one or more sides of the permeable electrical insulator, and wherein a side included in the one or more sides is proximate to the anode.

15. The method of claim 11, wherein the anode comprises lithium.

16. The method of claim 11, wherein the selectively permeable membrane increases a quantity of cycles the energy storage device can obtain prior to failure compared to the energy storage device without the selectively permeable membrane.

17. The method of claim 11, wherein the step of positioning the selectively permeable membrane proximate to the anode comprises applying the selectively permeable membrane to the surface of the anode.

18. The method of claim 11, wherein the graphene-based material is cross-linked.

19. The method of claim 11, wherein the selectively permeable membrane is initially formed on a substrate prior and then removed from the substrate prior to being positioned proximate to the anode.

20. The method of claim 11, wherein the anode comprises lithium or sodium.
